(19) United States
(12) Patent Application Publication
(10) Pub. No.: US 2026/0097539 A1
(43) Pub. Date: Apr. 9, 2026

(54) GUIDE PLATE FOR USE IN WOODWORKING CUTTING GUIDE

(71) Applicant: SUPER POWER TOOLS CO., LTD., Taichung City (TW)

(72) Inventor: Yu-Chun LIU, Taichung City (TW)

(21) Appl. No.: 18/910,446

(22) Filed: Oct. 9, 2024

(51) Int. Cl. B27C 5/00; B23Q 9/00

(52) U.S. Cl. CPC B27C 5/00; B23Q 9/0014

(57) ABSTRACT

Disclosed is a guide plate for use in a woodworking cutting guide, having a body. The body has a first surface and a second surface opposite to each other along the thickness direction of the body. Multiple through-holes extend through the body. Along the thickness direction, the body is sequentially formed with a guide hole, a mounting hole, and a recess. The guide hole communicates with the mounting hole and extends to the second surface. The mounting hole communicates with the recess, which extends to the first surface. A tapered surface forms the wall of the guide hole, thereby limiting and positioning a guide bushing along the radial direction of the guide hole.

### CROSS-REFERENCE TO RELATED APPLICATIONS

Not applicable.

### BACKGROUND OF THE INVENTION

The present invention relates to a component for woodworking machines, in particular, a guide plate designed for use in a cutting guide, where the guide plate is configured to equip a guide bushing.

Routers and grooving cutters are common woodworking tools used to mill wood materials. A cutting guide is an accessory that is installed on these tools and includes a guide plate that is configured to equip a guide bushing to serve as a guide for the machining path during the milling process.

As shown in FIGS. 1 and 2, the existing guide plate installed on the cutting guide comprises a plate-shaped body 10. The body 10 features an upper surface 11 and a lower surface 12 located on opposite sides of the body 10 in the thickness direction. The lower surface 12 is used to rest against the surface 92 of a wood material 91. Multiple through-holes 13 extend through the body 10, each allowing a bolt (not shown) to pass therethrough. These bolts are used to secure the body 10 to the cutting guide (not shown). The body 10 also includes a mounting hole 14 and a recess 15, with one end of the mounting hole 14 extending to the upper surface 11 and the other end communicating with the recess 15 extending to the lower surface 12.

A guide bushing 20 is installed on the body 10 and comprises a bushing body 21 and a retaining nut 22. The bushing body 21 is mainly composed of a threaded collar 23, a disc-shaped flange 24, and a tubular sleeve 25, all of which are formed in one piece. The threaded collar 23 is connected to one side of the disc-shaped flange 24, while the sleeve 25 is connected to the other side, with a through-hole 26 running through the bushing body 21.

To install the guide bushing 20 on the body 10, the threaded collar 23 is inserted from the bottom through the lower surface 12 and the recess 15, is positioned within the mounting hole 14, and protrudes upward through the upper surface 11. The disc-shaped flange 24 is embedded in the recess 15 and is in axial contact with the body 10. The retaining nut 22 is threaded onto the outer diameter of the threaded collar 23 and is in contact with the upper surface 11. The retaining nut 22 and the disc-shaped flange 24 hold the body 10 from opposite sides, thus completing the installation of the guide bushing 20.

A cutting tool 93, driven by the woodworking tool, is coaxially aligned with the bushing body 21 and extends through the lower end 28 of the sleeve 25 to process the cutting zone 94 of the wood material 91. The diameter of the through-hole 26 is larger than the outer diameter of the cutting tool 93, thereby ensuring that the cutting tool 93 and the bushing body 21 remain radially separated to prevent any contact between them.

During operation, the lower surface 12 of the body 10 is placed against the surface 92 of the wood material 91, while the outer diameter of the sleeve 25 is positioned against the guide surface 96 of the wood material 91. As the woodworking tool moves, the guide surface 96 directs the path of movement of the cutting tool 93, and the cutting zone 94 is milled by the portion of the cutting tool 93 extending from the lower end 28 of the sleeve 25.

In order to facilitate the installation of the guide bushing 20 on the body 10 and to accommodate guide bushings 20 of various brands and specifications, the diameter of the mounting hole 14 is made slightly larger than the outer diameter of the threaded collar 23, and the inner diameter of the recess 15 is made slightly larger than the outer diameter of the disc-shaped flange 24. Thus, a loose radial fit is produced between the bushing body 21 and the body 10, and the positioning of the bushing body 21 in the radial direction relies solely on the frictional contact between the disc-shaped flange 24, the retaining nut 22, and the body 10.

During the milling process, the sleeve 25 maintains lateral contact with the guide surface 96. The relative force exerted by the guide surface 96 on the sleeve 25 is directed toward the center of the bushing body 21 along its radial direction. This may easily cause the bushing body 21 to move radially relative to the body 10, bringing the cutting tool 93 closer to the guide surface 96. As a result, the distance D1 between a machined surface 97 produced by the cutting tool 93 milling the wood material 91 and the guide surface 96 becomes smaller than intended.

When the machined surface 97 needs to be formed near the guide surface 96, the cutting tool 93 will be positioned very close to the wall of the through-hole 26 in the radial direction of the sleeve 25. The above-mentioned movement of the bushing body 21 relative to the body 10 in the radial direction can easily cause the cutting tool 93 to come into contact with the wall of the through-hole 26, resulting in friction between the cutting tool 93 and the bushing body 21.

### SUMMARY OF THE INVENTION

The main purpose of the present invention is to provide a guide plate for use in a woodworking cutting guide.

In order to achieve the aforementioned purpose, the present invention adopts the following technical solution:

A guide plate for use in a woodworking cutting guide, comprising a body, wherein the body is a plate-shaped structure with a certain thickness. The body has a first surface and a second surface, with the first surface and the second surface opposite to each other along the thickness direction of the body, with the first surface being planar. Multiple through-holes extend through the body along its thickness direction.

The body is formed with a guide hole, a mounting hole, and a recess arranged sequentially along its thickness direction. The guide hole communicates with the mounting hole and extends to the second surface, while the mounting hole communicates with the recess which extends to the first surface. The body includes a tapered surface forming the wall of the guide hole. The diameter of the tapered surface increases from the first surface toward the second surface along the thickness direction of the body, thereby limiting and positioning a guide bushing along the diameter direction of the guide hole.

The guide hole allows the retaining nut of the guide bushing to enter, and the tapered surface provides a positional limitation on the retaining nut along the radial direction of the guide bushing, thereby enabling the body and the guide bushing to be fixed relative to each other in the radial direction.

### BRIEF DESCRIPTION OF DRAWINGS

FIG. 1 is a perspective view of a guide plate of the prior art.

FIG. 2 is a partial cross-sectional view of the guide plate in use of the prior art.

FIG. 3 is a perspective view of the preferred embodiment of the present invention.

FIG. 4 is a partial cross-sectional view of the preferred embodiment of the present invention.

FIG. 5 is a partial cross-sectional view of the preferred embodiment of the present invention in use.

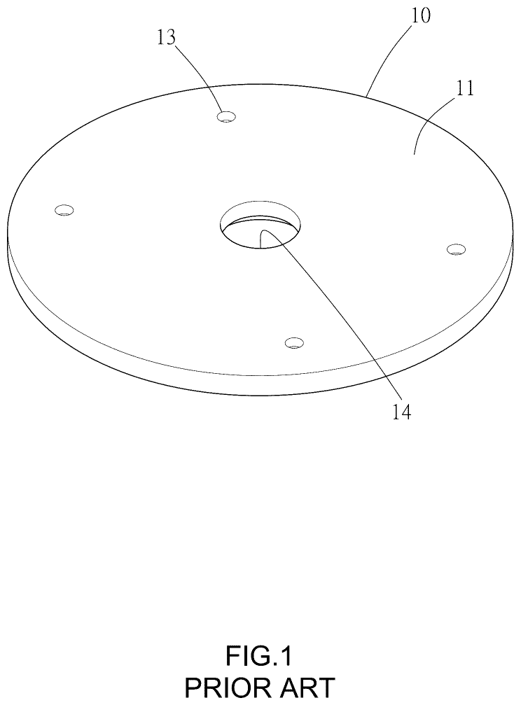

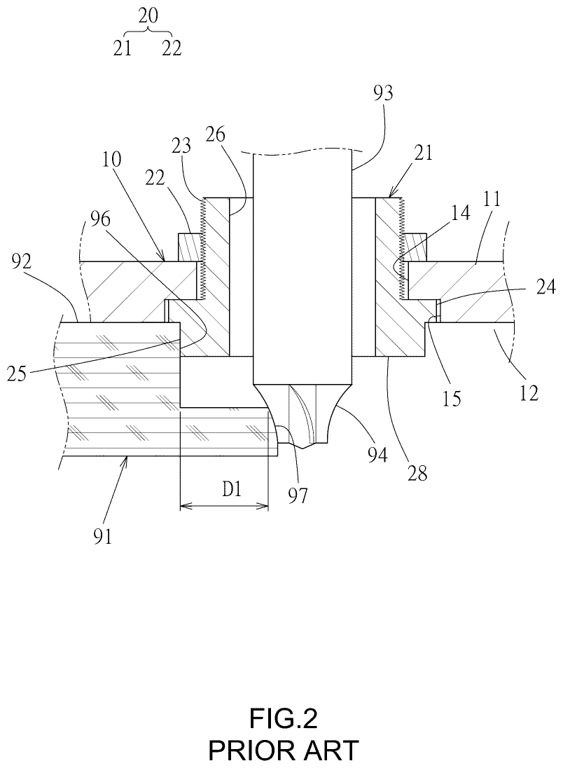

### DETAILED DESCRIPTION OF THE INVENTION

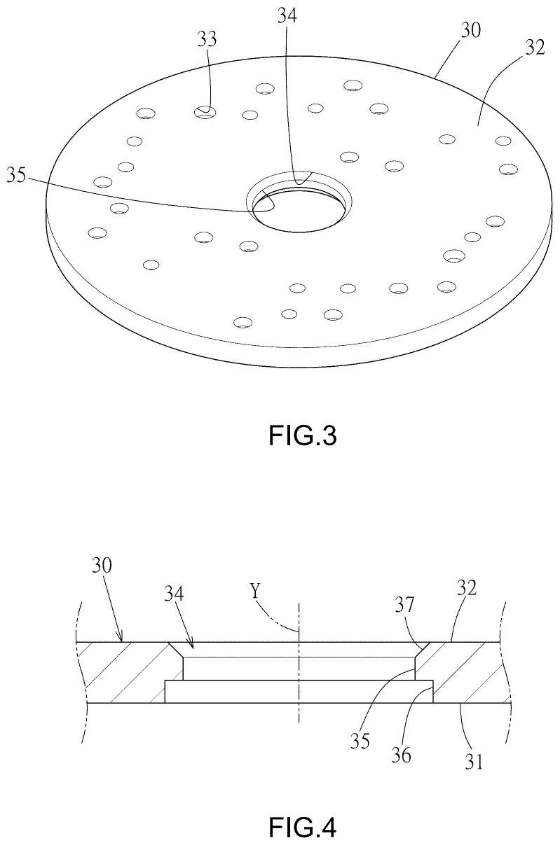

FIGS. 3 to 5 illustrate a preferred embodiment of a guide plate for use in a woodworking cutting guide of the present invention. However, this embodiment is for illustrative purposes only and does not limit the scope of the structure claimed in this patent application.

As shown in FIGS. 3 to 5, the preferred embodiment of the present invention includes a body 30. The body 30 is a plate-shaped structure with a certain thickness. The body 30 features a first surface 31 and a second surface 32 opposite to each other along the thickness direction, wherein the first surface 31 is planar. Multiple through-holes 33 extend through the body 30 along its thickness direction. Each through-hole 33 allows a bolt (not shown) to pass therethrough, so that the body 30 can be mounted onto a cutting guide (not shown) by means of these bolts.

The body 30 is formed with a guide hole 34, a mounting hole 35, and a recess 36 arranged sequentially along its thickness direction. The guide hole 34 communicates with the mounting hole 35 and extends to the second surface 32, while the mounting hole 35 communicates with the recess 36 which extends to the first surface 31. The radial centers of the guide hole 34, the mounting hole 35, and the recess 36 are preferably aligned along a virtual axis Y, which is formed along the thickness direction of the body 30.

The body 30 includes a tapered surface 37 forming the wall of the guide hole 34. The diameter of the tapered surface 37 increases from the first surface 31 toward the second surface 32 along the thickness direction of the body 30. This tapered surface 37 serves to limit and position the guide bushing 20 along the diameter direction of the guide hole 34, as described in the prior art.

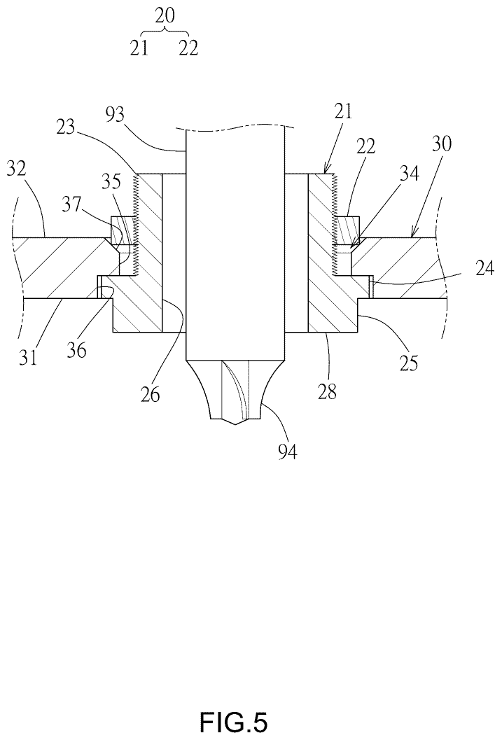

As shown in FIG. 5, when the guide bushing 20 is installed on the body 30, the threaded collar 23 passes from bottom through the first surface 31 and the recess 36, is positioned in the mounting hole 35, and protrudes upward through the guide hole 34 and the second surface 32 of the body 30. The disc-shaped flange 24 is embedded in the recess 36 and is in axial contact with the body 30. The retaining nut 22 is threaded onto the outer diameter of the threaded collar 23 and enters the guide hole 34 through the second surface 32 and abuts the tapered surface 37. Together, the retaining nut 22 and the disc-shaped flange 24 securely position the body 30 and complete the installation of the guide bushing 20.

The guide hole 34 allows the retaining nut 22 to enter, and the tapered surface 37 provides a positional limitation on the retaining nut 22 along the diameter direction of the guide bushing 20. In other words, the axial distance between the retaining nut 22 and the disc-shaped flange 24 is less than the distance between the second surface 32 and the recess 36. As a result, the body 30 and the guide bushing 20 are fixed relative to each other in the radial direction. Although the bushing body 21 has a loose fit with the body 30 in the radial direction, the threaded collar 23 and the tapered surface 37 press against each other. When the sleeve 25 laterally abuts against the guide surface of the wood material being milled (not shown), the force exerted by the wood material on the sleeve 25 is directed toward the center of the bushing body 21, thereby preventing any movement of the bushing body 21 relative to the body 30 in the diameter direction. The diameter differences between the mounting hole 35 and the outer diameter of the threaded collar 23, as well as the inner diameter of the recess 36 and the outer diameter of the disc-shaped flange 24, do not affect the distance between the cutting tool 93 and the guide surface. Therefore, the distance between the machined surface produced by the cutting tool 93 and the guide surface can be consistently maintained, thereby improving the precision of the processing dimensions.

The relative position of the guide bushing 20 and the body 30 in the radial direction remains unchanged due to the contact of the sleeve 25 with the wood material. This ensures that the distance between the cutting tool 93 and the wall of the through-hole 26 is maintained, thereby preventing friction between the cutting tool 93 and the bushing body 21.

1. A guide plate for use in a woodworking cutting guide, comprising a body having a thickness and a plate-shaped structure with a first surface and a second surface opposite to each other along the thickness direction of the body, with the first surface being planar, wherein multiple through-holes extend through the body along the thickness direction thereof; and wherein the body is formed with a guide hole, a mounting hole, and a recess arranged sequentially along the thickness direction, such that the guide hole communicates with the mounting hole and extends to the second surface, the mounting hole communicates with the recess extending to the first surface, and the body includes a tapered surface forming the wall of the guide hole, with the diameter of the tapered surface increasing from the first surface toward the second surface along the thickness direction of the body, thereby limiting and positioning a guide bushing along the radial direction of the guide hole.
